(19) United States
(12) Patent Application Publication
(10) Pub. No.: US 2004/0220005 A1
(43) Pub. Date: Nov. 4, 2004

(54) Pulley

(76) Inventor: Howard McGrath, Agawam, MA (US)

Correspondence Address: CANTOR COLBURN, LLP, 55 GRIFFIN ROAD SOUTH, BLOOMFIELD, CT, 06002

(21) Appl. No.: 10/427,277

(22) Filed: May 1, 2003

(51) Int. Cl. F16H 55/36

(52) U.S. Cl. 474/166; 474/174

(57) ABSTRACT

A method and apparatus for a pulley assembly comprises a pulley rim defining a cylinder having a thickness of less than about 0.031 inch. The pulley rim is configured from a rectangular shaped planar sheet of metal that is annularly shaped and welded at longitudinal ends defining opposite edges thereof aligned with each other and secured together using a high-energy weld. At least one hub is configured for press fit engagement at least partially within the cylinder defined by the rim and is further configured to receive a shaft therethrough.

### TECHNICAL FIELD

This disclosure relates to pulleys for driving belts and, more particularly, to such pulleys for the precision drive of belting.

### BACKGROUND

It is known in the prior art to use rotatable sprockets or toothed pulleys to engage with openings in an endless belt to drive the belt.

Alternatively, an endless toothed belt is driven by rotatable pulleys with the belt teeth engaging in appropriately spaced openings in the pulleys.

The pulleys contemplated hereof, for example, may be used in innumerable applications, but essentially they are employed where positive, accurate, and repeatable translation of pulley rotary motion to belt linear motion or vice versa is required. Frequently these are indexing movements with a stepper motor as in automated production lines where a continuous stream of product is indexed very accurately from one manufacturing operation to the next, until off-loaded at the end of the belt as a finished product.

Such arrangements have been complicated in their structures, unreliable in their use, and expensive in their manufacture. Furthermore, such arrangements having complicated structure reduces the ability to drive the resulting pulley system with precision or accuracy.

Thus, it is desired to provide a pulley system to drive or be driven by corresponding belting with more precision or accuracy.

### SUMMARY

Herein is provided a low inertia pulley which is compatible with thin belting, is simple in its structure, inexpensive in its manufacture, and may provide the advantages of a sprocket tooth or timing belt drive.

A further advantage disclosed herein is improved performance of a timed belt drive while at the same time reducing the cost of the pulleys needed for such a belt system.

In an exemplary embodiment, a low inertia pulley assembly includes a pulley rim defining a cylinder having a thickness of less than about 0.031 inch. The pulley rim is configured from a rectangular shaped planar sheet of metal that is annularly shaped and welded at longitudinal ends defining opposite edges thereof aligned with each other and secured together using a high-energy weld. At least one hub is configured for press fit engagement at least partially within the cylinder defined by the rim and is further configured to receive a shaft therethrough.

In another exemplary embodiment a method for fabricating a low inertia pulley assembly includes using a rectangular shaped planar sheet of metal having a thickness of less than about 0.031 inch; aligning longitudinal ends defining opposite edges of the rectangular shaped planar sheet of metal to form an annularly shaped pulley rim; securing the ends with each other using a high-energy weld to define a cylinder having a thickness of less than about 0.031 inch; and configuring at least one hub for press fit engagement at least partially within the cylinder defined by the rim and to receive a shaft therethrough.

### BRIEF DESCRIPTION OF THE DRAWINGS

FIG. 1 is a front elevational view of an exemplary embodiment of a welded pulley rim.

FIG. 2 is an end elevational view of the pulley rim of FIG. 1.

FIG. 3 is a front elevational view of an exemplary embodiment of a hub for insertion within the pulley rim.

FIG. 4 is a front elevational view of the hub of FIG. 3.

FIG. 5 is a front elevational view of an exemplary embodiment of a pulley assembly including the welded pulley rim of FIG. 1 having two hubs inserted at two opposing ends defining the pulley assembly.

FIG. 6 is an end elevational view of the pulley assembly of FIG. 5.

FIG. 7 is a front elevational view of an alternative exemplary embodiment of a pulley assembly having spherical tooth hubs partially inserted at the two opposing ends defining the alternative pulley assembly.

FIG. 8 is an end view of the alternative pulley assembly of FIG. 7.

FIG. 9 is a perspective view of a pair of spherical tooth pulleys having a perforated belt entrained therearound.

### DETAILED DESCRIPTION

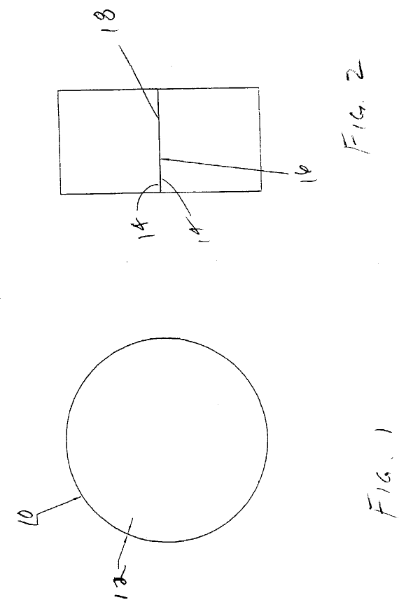

Referring to FIGS. 1 and 2, a welded pulley rim is shown generally at 10. Rim 10 may be fabricated from a variety of materials, such as any metal of various hardness and alloy. These could include stainless steel, carbon steel, aluminum, titanium and inconel, any of which may be coated with other materials to change surface properties or characteristics depending on the implementation of rim 10. For example, it is also contemplated that rim 10 may be employed as a dryer drum having a plurality of apertures configured therein for heated or cooled air to pass therethrough. It is also contemplated that the apertures may take the shape of any number of geometric shapes (e.g., square, diamond, circular, triangular, and the like, for example).

Rim 10 preferably has a thickness shown generally at 12 between about 0.002 inch to about 0.031 inch. Rim 10 more preferably has a thickness 12 between about 0.01 inch to about 0.023 inch, and most preferably between about 0.015 inch to about 0.020 inch.

In an exemplary embodiment, rim 10 preferably has a rim thickness 12 that is dependent on the diameter of the rim 10. More specifically, the thickness of rim 10 varies with the ratio of diameter to thickness in a range of about 300:1 to about 500:1. Rim 10 more preferably has a rim diameter to thickness ratio closer to about 400:1.

Rim 10 is generally formed using a rectangular elongated strip of a suitable material by bringing the longitudinal ends defining a length thereof into abutting relationship and securing them together such as by high energy welding. A generally cylindrical shape member is obtained which provides a suitable rim for the fabrication of a pulley assembly.

Rim 10 is preferably formed from a rectangular shaped planar sheet of metal that is annularly shaped and welded at ends 14 defining opposite edges thereof aligned with each other and then secured together using a high-energy welding means. As shown in FIGS. 1 and 2, ends 14 illustrate a strip of metal having corresponding cuts 18 being straight or normal to another pair of opposite edges defining a length thereof. By joining ends 14 or cuts 18, a circumferentially continuous rim 10 is formed.

Means for high-energy welding ends 14 together preferably include using a laser weld or an electron beam weld shown generally at 16. Prior to the present disclosure, weldment of edges of metal having a generally rectangular elongated strip of a suitable material by bringing the longitudinal ends 14 thereof into abutting relationship and securing them together such as by welding or brazing has been done with much thicker strips of material. In either event, a generally cylindrical shape member is obtained providing a high inertia blank for the fabrication of a pulley rim. However, providing a low inertia blank having a thickness 12 less than 0.031 inch has been unknown and has proved to be unsuccessful with materials such as stainless steel. Moreover, weldment of rim 10 having a thickness of about 0.031 inch and less has been unknown. Still further, weldment of a planar edges of rim 10 having a thickness between about 0.002 inch to about 0.031 inch has been unknown.

It should be noted that the particular shape of the cut 18 may take any one of various possible forms. The cut may be straight as illustrated; the cut may be such that a projecting tab is formed at one end of the convolution and a complementary slot is formed in the opposite end; or the cut may be made in other forms. Thus it should be apparent that the invention provides a high degree of versatility and is applicable to numerous specific pulley designs. It will also be appreciated that the invention has the important advantage of requiring a minimum of capital equipment. Thus the invention may be practiced with efficiency and economy. Should changes in the design of the finished pulley assembly be required, such changes can be made with minimum revision to the existing equipment and tooling and this adds further versatility to the invention. This is in marked contrast to other types of pulley constructions which utilize multiple dies and equipment and which involve more extensive modification when design changes in the pulley are made.

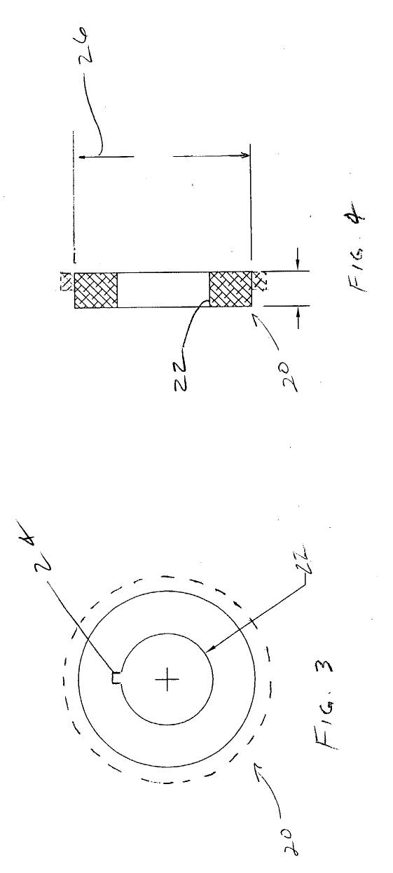

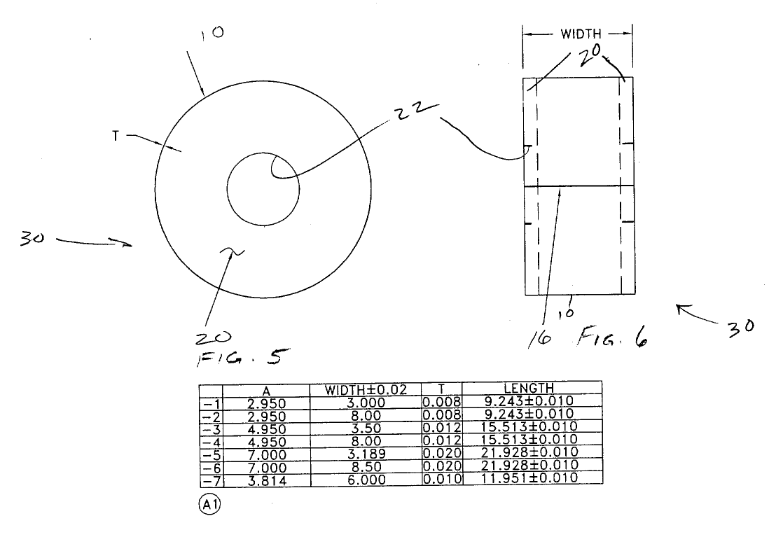

Referring now to FIGS. 3 and 4, a hub is shown generally at 20. Hub 20 is cylindrically shaped defined by an aperture 22 for receiving a drive shaft (not shown) therethrough. Aperture 22 may be further defined having a keyway 24 configured therein to limit rotation of hub 20 relative to a drive shaft connected thereto. The pulley assembly then can be coupled to the drive shaft using the keyway 24 and a set-screw arrangement as known in the art (e.g., a set-screw accepting threaded bore). The pulley assembly may also be coupled to the drive shaft by means of a separate clamping device. Hub 20 preferably has an outside diameter 26 preferably sized about 0.001 inch to about 0.003 inch larger than an inside diameter defined by rim 10, such that hub 20 may be at least partially received by press fit engagement within rim 10. It will also be pointed out that hub 20 preferably includes a lip 28 (shown with phantom lines) at an opposite end at which hub 20 is received by press fit engagement within rim 10. In this manner, a belt (not shown) entrained around rim 10 will be maintained as such by employing a pair of hubs 20 each having a lip 28 at either end of rim 10 to contain the belt from slipping off the resulting pulley assembly. It has also been found that employing a lip 28 on each hub 20 at opposite ends of rim 10 aids in maintaining press fit engagement between hubs 20 and rim 10 by limiting motion therebetween caused by an unrestrained belt operably coupled to rim 10.

Hub 20 is preferably fabricated from a metal having a coefficient of thermal expansion similar to or greater than a coefficient of thermal expansion of rim 10. It is preferred that hub 20 has the same or a larger coefficient of thermal expansion to ensure that hub 20 remains in press fit engagement with rim 10. In an exemplary embodiment depicted in FIGS. 3 and 4, hub 20 is preferably aluminum, and more preferably fabricated with 6061-T6 aluminum. It will be recognized by one skilled in the pertinent art that many other metal materials may be employed for hub 20.

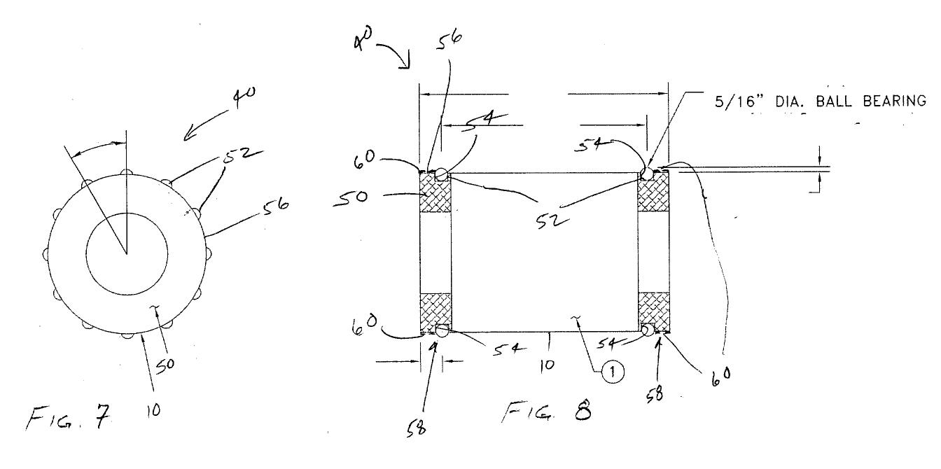

Referring now to FIGS. 5 and 6, an exemplary embodiment of a pulley assembly 30 is illustrated. Pulley assembly 30 includes two hubs 20 disposed in both openings defined by a cylinder formed by high-energy welding rim 10 at weld 16. In this manner, the two hubs 20 are in facing parallel relationship and aligned to receive a drive shaft through respective apertures 22 thereof. Again, as before, rim 10 defines a cylinder having a thickness “T” or 12 of about 0.002 inch to about 0.031 inch. Rim 10 more preferably has a thickness 12 between about 0.01 inch to about 0.023 inch, and most preferably between about 0.015 inch to about 0.020 inch.

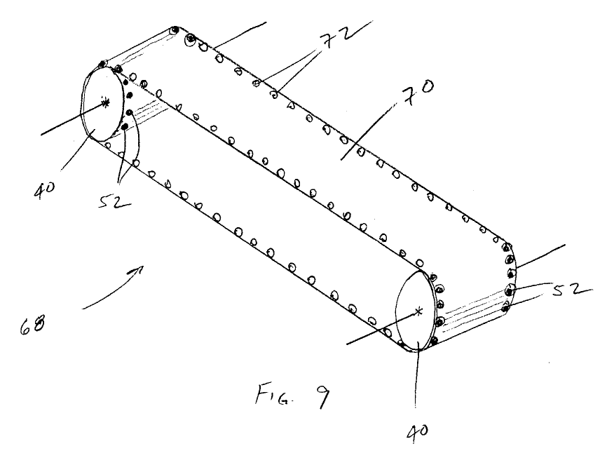

Referring now to FIGS. 7 and 8, an alternative exemplary embodiment of the pulley assembly 30 of FIGS. 5 and 6 is generally shown at 40. Pulley assembly 40 includes rim 10 having two hubs 50 partially inserted within rim 10. Each hub includes a plurality of spherical balls 52 that are press fit into circumferentially-spaced annular openings 54 in an outer peripheral wall 56 defining each hub 50. Balls 52 may be fabricated from hardened steel, ceramic or thermoplastic such as ultra high molecular weight (UHMW) polypropylene or the like. By this arrangement, balls 52 are firmly and rigidly supported relative to pulley 40.

Alternatively, each annular opening 54 communicates with a rectangular opening 58 formed in an adjacent portion of rim 10 when hubs 50 are fully inserted as depicted by phantom lines 60 indicative of rim 10 extending fully over outer peripheral wall 56 of each hub 50. In either arrangement discussed above, balls 52 are firmly and rigidly supported relative to pulley 40.

As seen in FIG. 9, a pulley system 68 illustrates thin belting in the form of an endless belt 70 entrained about a pair of pulleys 40. Belt 70 has a series of spaced openings 72 therethrough on its outboard ends or belt edges defining belt 70 running parallel to a longitudinal axis of appropriate size and spacing so as to be engageable by the balls 52 on the pulleys 40 which act in the manner of rounded teeth to drive the belt.

Of course, openings 72 in belt 70 may be positioned on other than both outboard ends defining belt 70 parallel to the central longitudinal axis. For example, they may be disposed along one belt edge or otherwise disposed as appropriate to interface with balls 52 on pulleys 40.

The belting may be fabricated from metal, fiberglass, fabric, rubber, polyurethane or thermoplastic materials such as Mylar, Kapton, or the like. Belting 70 is preferably fabricated as a steel belt so as to be formed as a thin belt.

Pulleys 40 are typically motor driven, and all types of motors are used, such as AC and DC, stepper motors, servo motors, constant speed motors, and the like, not shown. However, it will be recognized that many other applications are contemplated, including applications that use a stepper motor, for example, where system response of the corresponding belting and pulley assembly is critical.

As generally depicted in FIG. 9, the dimensions of pulley 40 and balls 52 and their relative positions may be carefully tailored to meet various belt drive requirements, with the portion of each ball disposed outwardly of pulley outer peripheral wall 56 acting much in the manner of a rounded sprocket tooth for engagement in the openings 72 of belt 70.

A wide variety of ball, pulley and belt dimensions and pulley profiles may be employed to adapt to any precision belt drive requirement.

The above described embodiments of pulley assemblies yield a very low inertia compared with conventional designs employing extruded or seamless tube stock materials. The key to the low inertia pulley is the utilization of a thin strip of metal, e.g., stainless steel, welded as an endless strip to form the body of the pulley assembly for later press fit engagement with at least one hub.

While preferred embodiments have been shown and described, various modifications and substitutions may be made thereto without departing from the spirit and scope of the invention, including the use of the geometries taught in other conventional pulley/belt drive assemblies. Accordingly, it is to be understood that the apparatus and method have been described by way of illustration only, and such illustrations and embodiments as have been disclosed herein are not to be construed as limiting to the claims.

1. A low inertia pulley assembly comprising:
a pulley rim defining a cylinder having a thickness of less than about 0.031 inch, said pulley rim configured from a rectangular shaped planar sheet of metal that is annularly shaped and welded at longitudinal ends defining opposite edges thereof aligned with each other and secured together using a high-energy weld; and
at least one hub configured for press fit engagement at least partially within said cylinder defined by said rim, said at least one hub configured to receive a shaft therethrough.

2. The assembly of claim 1, wherein said thickness of said rim is between about 0.002 inch and about 0.031 inch.

3. The assembly of claim 1, wherein said thickness of said rim is between about 0.01 inch and about 0.023 inch.

4. The assembly of claim 1, wherein said thickness of said rim is between about 0.015 inch and about 0.020 inch.

5. The assembly of claim 1, wherein said high energy weld includes one of a laser weld and an electron beam weld.

6. The assembly of claim 1, wherein said metal includes one of stainless steel, carbon steel, aluminum, titanium and inconel.

7. The assembly of claim 1, wherein said at least one hub is defined by an outside diameter larger than an inside diameter defined by said rim to facilitate said press fit engagement therebetween.

8. The assembly of claim 1, wherein said at least one hub has a coefficient of thermal expansion that is one of similar to and greater than a coefficient of thermal expansion of said rim.

9. The assembly of claim 1, wherein said at least one hub includes two hubs, each hub disposed at least partially within said rim at opposite openings of said cylinder defined by said rim.

10. The assembly of claim 9, wherein said each hub includes a plurality of spherical balls press fit into circumferentially-spaced annular openings configured in an outer peripheral wall defining said each hub.

11. The assembly of claim 10, wherein said balls are fabricated from one of a hardened steel, a ceramic and a thermoplastic.

12. The assembly of claim 11, wherein each annular opening of said circumferentially-spaced annular openings communicates with a rectangular opening formed in an adjacent portion of said rim when said each hub is fully inserted within said rim.

13. The assembly of claim 1, wherein said hub is aluminum.

14. The assembly of claim 1, wherein said thickness of said rim is dependent on a ratio of a diameter of said rim to said thickness of said rim in a range of about 300:1 to about 500:1.

15. A method of fabricating a low inertia pulley assembly, the method comprising:
using a rectangular shaped planar sheet of metal having a thickness of less than about 0.031 inch;
aligning longitudinal ends defining opposite edges of said rectangular shaped planar sheet of metal to form an annularly shaped pulley rim;
securing said ends with each other using a high-energy weld to define a cylinder having a thickness of less than about 0.031 inch;
configuring at least one hub for press fit engagement at least partially within said cylinder defined by said rim; and
configuring said at least one hub to receive a shaft therethrough.

16. The method of claim 15, wherein said thickness of said rim is between about 0.002 inch and about 0.031 inch.

17. The method of claim 15, wherein said thickness of said rim is between about 0.01 inch and about 0.023 inch.

18. The method of claim 15, wherein said thickness of said rim is between about 0.015 inch and about 0.020 inch.

19. The method of claim 15, wherein said high energy weld includes one of a laser weld and an electron beam weld.

20. The method of claim 15, wherein said metal includes one of stainless steel, carbon steel, aluminum, titanium and inconel.

21. The method of claim 15, wherein said at least one hub is configured having an outside diameter larger than an inside diameter defined by said rim to facilitate said press fit engagement therebetween.

22. The method of claim 15, wherein said at least one hub has a coefficient of thermal expansion that is one of similar to and greater than a coefficient of thermal expansion of said rim.

23. The method of claim 15, wherein said at least one hub includes two hubs, each hub disposed at least partially within said rim at opposite openings of said cylinder defined by said rim.

24. The method of claim 23, wherein said each hub includes a plurality of spherical balls press fit into circumferentially-spaced annular openings configured in an outer peripheral wall defining said each hub.

25. The method of claim 24, wherein said balls are fabricated from one of a hardened steel, a ceramic and a thermoplastic.

26. The method of claim 25, wherein each annular opening of said circumferentially-spaced annular openings communicates with a rectangular opening formed in an adjacent portion of said rim when said each hub is fully inserted within said rim.

27. The method of claim 15, wherein said hub is aluminum.

28. The method of claim 15, wherein said thickness of said rim is dependent on a ratio of a diameter of said rim to said thickness of said rim in a range of about 300:1 to about 500:1.

29. A motion transmitting system including a pair of coacting driving and driven transmission members consisting of:
a first member in the form of an endless belt having a longitudinally-extending series of through openings at predetermined intervals therealong,
a second member in the form of a low inertia pulley having an outer peripheral annular wall having a thickness of less than about 0.031 inch supported radially outwardly by at least one hub press fit within a cylinder defined by the annular wall, there being a series of the circular through openings in at least one of wall and the hub continuously positioned in the circumferential direction at the corresponding predetermined intervals,
the first member being trained on the second member,
a plurality of spherical elements,
each spherical element being disposed in the second member through one of the circular through openings and into its respective well and retained therein by a press fit in defining outwardly extending projections of hemispherical configuration, each projection being defined by a half sphere formed by the plane through the center of the spherical element extending radially outwardly from the periphery of the second member at the said predetermined intervals therearound for presenting a series of hemispherical teeth adapted to cooperate with and be engageable in the correspondingly spaced and shaped through openings of the first member in effecting a driving relationship between the first and second members.
